(19) United States
(12) Patent Application Publication
(10) Pub. No.: US 2023/0352228 A1
(43) Pub. Date: Nov. 2, 2023

(54) TWO-LAYER TRANSFORMER

(71) Applicant: TEXAS INSTRUMENTS INCORPORATED, Dallas, TX (US)

(72) Inventors: Nicola BERTONI, Freising (DE); Raul BLECIC, Freising (DE); Giacomo CALABRESE, Freising (DE)

(21) Appl. No.: 17/733,399

(22) Filed: Apr. 29, 2022

(51) Int. Cl. H01F 27/28; H01F 27/29; H02M 3/335

(52) U.S. Cl. CPC H01F 27/2804; H01F 27/29; H02M 3/335; H01F 2027/2809

(57) ABSTRACT

An apparatus includes a substrate. A first conductive layer is on the substrate. The first conductive layer includes a first set of conductive segments and a second set of conductive segments. A second conductive layer is over the first conductive layer opposite the substrate. The second metal layer includes a third set of conductive segments and a fourth set of conductive segments. A first set of vias is between the first set of conductive segments and the third set of conductive segments. The first set of conductive segments, the third set of conductive segments, and the first set of vias form a first transformer winding. A second set of vias is between the second set of conductive segments and the fourth set of conductive segments. The second set of conductive segments, the fourth set of conductive segments, and the second set of vias form a second transformer winding.

### BACKGROUND

A transformer generally includes two conductive windings (also referred to as coils or inductors)—a “primary” winding and a “secondary” winding. Many types of circuits include transformers. For example, an isolation voltage converter converts an input direct current (DC) voltage to a different, output DC voltage using a transformer. A conventional isolation voltage converter is a package having an isolation transformer coupled to two separate dies by way of bond wires. One die includes a circuit coupled to the primary winding of the transformer, and the other dies includes another circuit coupled to the secondary winding of the transformer. The dies also are coupled to a leadframe by way, of bond wires. Due to the use of bond wires, such a package tends to be relatively large and expensive to fabricate. Further, the bond wires introduce additional parasitic inductance which may cause additional ringing on the internal supply rails and reduce the coupling efficiency through the transformer as well as the reliability over the life-time of the voltage converter.

### SUMMARY

In at least one example, an apparatus includes a substrate and a first conductive layer is on the substrate. The first conductive layer includes a first set of conductive segments and a second set of conductive segments. A second conductive layer is over the first conductive layer opposite the substrate. The second metal layer includes a third set of conductive segments and a fourth set of conductive segments. A first set of vias is between the first set of conductive segments and the third set of conductive segments. The first set of conductive segments, the third set of conductive segments, and the first set of vias form a first transformer winding. A second set of vias is between the second set of conductive segments and the fourth set of conductive segments. The second set of conductive segments, the fourth set of conductive segments, and the second set of vias form a second transformer winding.

### BRIEF DESCRIPTION OF THE DRAWINGS

FIG. 1 is a circuit schematic of an isolation voltage converter including a transformer, in accordance with an example.

FIG. 2 is a circuit schematic of a primary-side power stage for use in the isolation voltage converter of FIG. 1, in accordance with an example.

FIG. 3 is a perspective view of a two-layer transformer with each winding including two turns, in accordance with an example.

FIG. 4 is a side view of the two-layer transformer of FIG. 3, in accordance with an example.

FIG. 5 is a perspective view of the two-layer transformer of FIG. 3 depicting the conductive segments of the two layers that form each of the transformer's windings, in accordance with an example.

FIG. 6 is a perspective view of a two-layer transformer with each winding including three turns, in accordance with an example.

FIG. 7 is a side view of the two-layer transformer of FIG. 6, in accordance with an example.

### DETAILED DESCRIPTION

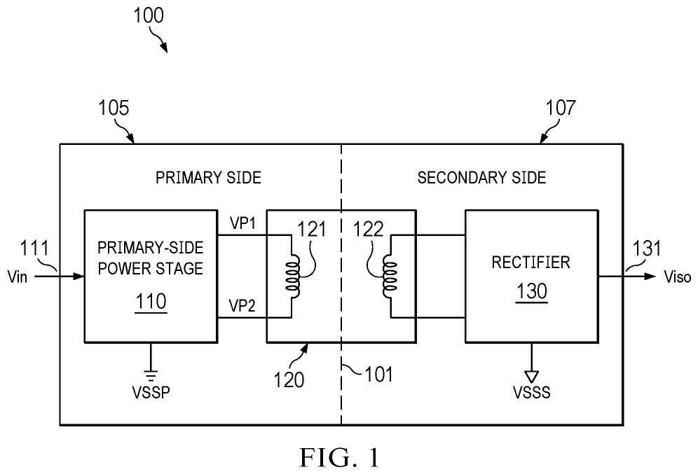

FIG. 1 is a block diagram of an isolation voltage converter 100 in accordance with an example embodiment. The isolation voltage converter 100 has a primary side 105 and a secondary side 107. The isolation voltage converter 100 includes a transformer 120 that is operable as an isolation transformer to galvanically isolate the primary side 105 from the secondary side 107. The dashed line 101 delineates the primary side 105 from the secondary side 107. No electrical connection is present between the primary and secondary sides. The terms “primary” and “secondary” refer to the primary and secondary inductors (also referred to as coils or windings) of the transformer 120.

The primary side 105 includes a voltage input 111. The DC input voltage provided to the voltage input 111 is labeled Vin. The secondary side 107 includes a voltage output 131. The isolated output voltage from the voltage output 131 is Viso. The primary side 105 includes a primary-side power stage 110. The secondary side 107 includes a rectifier 130. In one example, the rectifier 130 is a full-bridge rectifier comprising four diodes, although other implementations of the rectifier are possible as well. The primary side 105 has a ground Vssp. The secondary side 107 has a ground Vsss. The grounds Vssp and Vsss are isolated from each other.

The transformer 120 has a primary winding 121 and a secondary winding 122. The primary-side power stage 110 receives Vin, and switch nodes VP1 and VP2 of the primary-side power are coupled to the terminals of the primary winding 121 of the transformer 120 as shown. The rectifier 130 is coupled to the secondary winding 122 of the transformer 120. The rectifier 130 converts the time-varying voltage from the secondary winding 122 of the transformer to the DC output voltage Viso. The voltages Vin and Viso do not share the same ground and are galvanically isolated from each other.

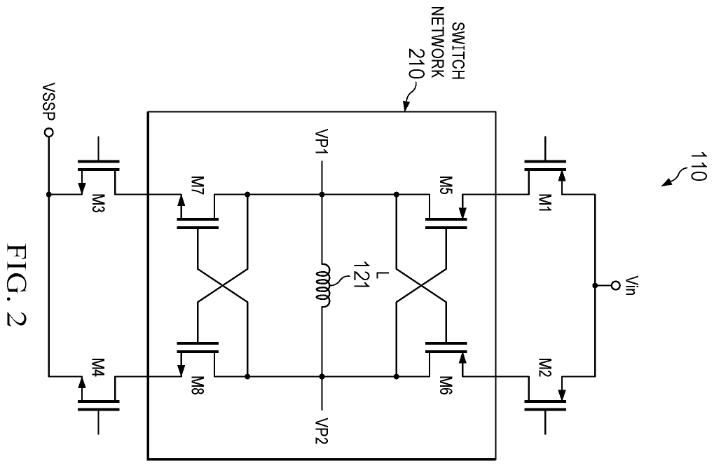

The primary-side power stage 110 causes a switching voltage waveform to be provided to the primary winding 121 of the transformer 120 to thereby cause energy to be transferred through the transformer to the secondary winding. Numerous implementations are possible for the primary-side power stage 110 and within the scope of this disclosure. FIG. 2 is a schematic diagram illustrating one example implementation of the primary-side power stage 110. In this example, the primary-side power stage 110 includes transistors M1-M4 and a switch network 210. The switch network 210 includes two pairs of cross-coupled transistors. One pair of cross-coupled transistors includes transistors M5 and M6 and the other pair of cross-coupled transistors includes transistors M7 and M8. M1, M2, M5, and M6 are p-channel field effect transistors (PFETs), and M3, M4, M7, and M8 are p-channel field-effect transistors (NFETs). The sources of M1 and M2 are coupled together and receive Vin. The sources of M3 and M4 are coupled together at ground Vssp. The drain of M1 is coupled to the source of M5, and the drain of M2 is coupled to the source of M6. The gate of M5 is coupled to the drain of M6, and the gate of M6 is coupled to the drain of M5.

The drains of M5 and M7 are coupled together at the switch node VP1, and the drains of M6 and M8 are coupled together at the switch node VP2. The gate of M7 is coupled to the drain of M8, and the gate of M8 is coupled to the drain of M7. The source of M7 is coupled to the drain of M3, and the source of M8 is coupled to the drain of M4. The terminals of the primary winding 121 of the transformer 120 are coupled to the switch nodes VP1 and VP2.

In one embodiment, M1, M2, M3, and M4 are lower voltage-rated transistors than M5, M6, M7, and M8. The voltage rating of the transistor refers to the maximum allowed drain-to source voltage (Vds) and the maximum allowed gate-to-source voltage (Vgs). A lower voltage rated transistor has a better Figure of Merit (FoM) in terms of the product of the on-resistance and the gate charge (Rdson*Qg), which means that lower voltage-rated transistors produce lower loss when switching at a higher frequency compared to a transistor rated for higher voltages. In one specific example, each of M5-M8 are 5V transistors (maximum allowed Vds or Vgs is 5V), and M1-M4 are 1.5V transistors (maximum allowed Vds or Vgs is 1.5V).

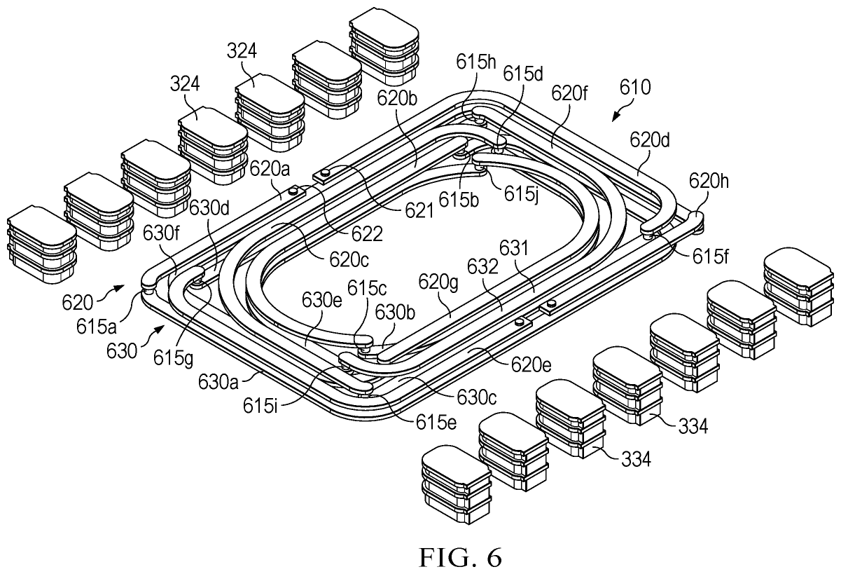

M1, M2, M3, and M4 are actively driven through the use of control signals discussed below with reference to FIG. 6. During operation, the control signals are asserted in a manner to cause M2 and M3 to be on concurrently, while M1 and M4 are off, and then to cause M1 and M4 to be on, while M2 and M3 off. The on and off states of M1-M4 repeats—M1 and M4 on (M2 and M3 off), then M2 and M3 on (M1 and M4 off), then M1 and M4 on again (M2 and M3 off), and so on.

The on and off states of the cross-coupled transistors M5/M6 and M7/M8 are controlled as a result of the on/off states of M1-M4. That is, M5-M8 are not actively driven by independently supplied control signals as otherwise is the case for M1-M4. For example, with M2 and M3 on (and M1 and M4 off), M6 and M7 also are on (and M5 and M6 are off). In this portion of each switching cycle, of the eight transistors, M2, M6, M7, and M3 are on and the remaining transistors are off. With M2 and M6 being on, switch node VP2 is pulled high towards Vin, and with M3 and M7 being on, switch node VP1 is pulled low towards Vssp. In the opposite state of the switching cycle (M1, M5, M8, and M4 being on, and M2, M6, M7, and M3 being off), switch node VP1 is pulled high towards Vin and switch node VP2 is pulled low towards Vssp.

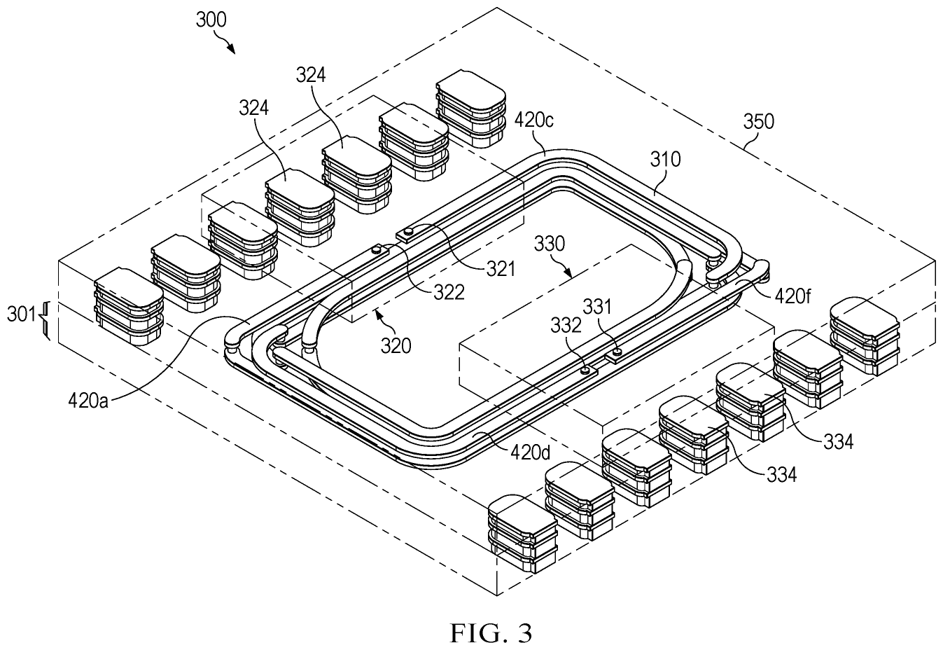

FIG. 3 shows an example of a device 300. The device 300 is an isolation voltage converter which includes a transformer 310 (usable as transformer 120), a first semiconductor die 320, a second semiconductor die 330, and leadframe contacts 324 and 334. The transformer 310 and leadframe contacts 324 and 334 are fabricated as part of a substrate 301. The substrate 301 advantageously also provides a support structure for the semiconductor dies 320 and 330. The transformer 310 (shown and described in further detail below) includes a primary winding and a secondary winding. One of the windings has terminals 321 and 322. The other winding has terminals 331 and 332. For example, the primary winding may have the terminals labeled 321 and 322, while the secondary winding has the terminals labeled 331 and 332.

Semiconductor die 320 partially overlaps the transformer 310 and has contact points (not specifically shown) that couple to terminals 321 and 322 of one of the transformer windings. Similarly, semiconductor die 330 overlaps the opposite side of the transformer 310 and has contact points that couple to terminals 331 and 332 of the other of the transformer winding. Because a portion of each of the semiconductor dies 320 and 330 overlaps and is positioned immediately adjacent the portion of the transformer 310 which includes the respective terminals, bond wires advantageously are not needed and thus not included in this arrangement. Parasitic inductance which otherwise results from the use of bond wires is reduced thereby increasing the coupling efficiency through the transformer which in turn creates higher power efficiency. The semiconductor dies 320 and 330 also directly couple to leadframe contacts 324 and 334 as shown, also without the use of bond wires. Mold compound 350 may be used to encapsulate and protect the transformer 310 and semiconductor dies 320 and 330.

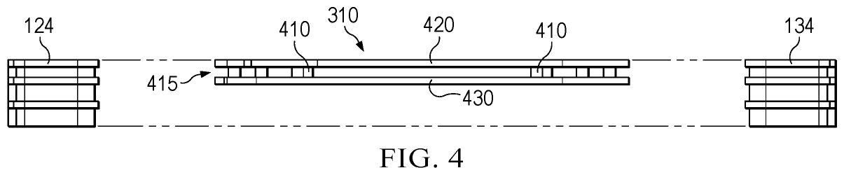

The transformer 310 described herein is a two-layer transformer. FIG. 4 shows a side view of transformer 310. The transformer 310 includes a first layer 420 and a second layer 430. Each layer 420, 430 may be implemented as metal or other suitable, conductive material to form windings of a transformer. The two layers are separated by dielectric material 415 (e.g., silicon dioxide). Each layer is formed to have multiple conductive segments (described below) with metal-lined vias 410 interconnecting some of the conductive segments of layer 420 with some of the conductive segments of layer 430. The primary winding of the transformer 310 includes some of the conductive segments of each of the two metal layers 420, 430 with interconnecting vias 410. Similarly, the secondary winding also includes conductive segments (different than the conductive segments forming the primary winding) with interconnecting vias 410.

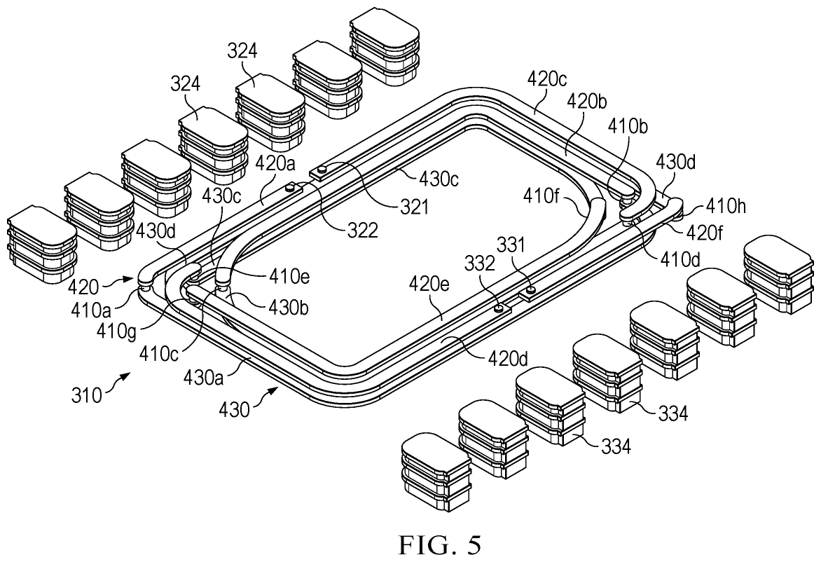

FIG. 5 is a perspective view of the transformer 310. Each metal layer 420 and 430 is patterned to include multiple conductive segments as shown. The conductive segments of each winding of the transformer are labeled with the conductive segments of layer 420 labeled with the numeral “420” and an appended letter (e.g., 420a, 420b, 420c, etc.). The conductive segments of layer 430 are labeled with the numeral “430” and an appended letter (e.g., 430a, 430b, 430c, etc.). Some conductive segments are predominantly linear (e.g., segment 420a) and some conductive segments have curved (or right-angle) corners (e.g., segment 420c). The interconnecting vias 410 also are similarly labeled (410a, 410b, 410c, etc.).

The conductive segments and associated vias 410 of one transformer winding (e.g., the primary winding) of the transformer 310 will now be identified starting at terminal 322 with conductive segment 420a and progressing toward the end of the winding at terminal 321. At the opposite end of conductive segment 420a from terminal 322, via 410a couples conductive segment 420a from layer 420 to conductive segment 430a in layer 430. Conductive segment 430a extends from via 410a around the opposite side of the transformer to via 410b. Via 410b couples conductive segment 430a from layer 430 to conductive segment 420b back in layer 420. Conductive segment 420b extends around the transformer inside conductive segment 420a to via 410c. Via 410c couples conductive segment 420b from layer 420 to conductive segment 430b in layer 430. Conductive segment 430b in layer 430 extends back around the transformer inside conductive segment 430a to via 410d. Finally, via 410d couples conductive segment 430b in layer 430 to conductive segment 420c in layer 420. Conductive segment 420c wraps around a portion of the transformer as shown. The end of conductive segment 420c is near (but does not touch) the initial conductive segment 420a. Terminal 322 is on the end of the conductive segment 420c near terminal 322. The semiconductor die 320 (FIG. 3) is at least partially supported by conductive segments 420a and 420c as well as by the leadframe contacts 324.

The other winding (e.g., the secondary winding) of the transformer 310 is similarly constructed and is interleaved within the winding described above. The conductive segments and vias of this latter winding will now be identified starting at terminal 332 with conductive segment 420d and progressing towards terminal 331. At the opposite end of conductive segment 420d from terminal 332, via 410e couples conductive segment 420d from layer 420 to conductive segment 430c in layer 430. Conductive segment 430c extends from via 410e around the opposite side of the transformer to via 410f. Via 410f couples conductive segment 430c from layer 430 to conductive segment 420e in layer 420. Conductive segment 420e extends around the transformer inside conductive segment 420d to via 410g. Via 410g couples conductive segment 420e from layer 420 to conductive segment 430d in layer 430. Conductive segment 430d in layer 430 extends back around the transformer to via 410h. Finally, via 410h couples conductive segment 430d in layer 430 to conductive segment 420f in layer 420, the opposite end of which includes terminal 331. The semiconductor die 330 (FIG. 3) is at least partially supported by conductive segments 420d and 420f as well as by the leadframe contacts 334.

The windings described above are interleaved with each other using two layers 420 and 430. As shown and described above, each winding transitions from one layer (420 or 430) to the other layer through a via at the corners of the transformer. Further, each winding described above with respect to FIG. 5 has approximately two full turns.

FIG. 6 is a perspective view of a three-turn transformer 610. Dies 320 and 330 may be coupled to and supported by transformer 610 as described above with regard to transformer 310 and shown in FIG. 3. Transformer 610 has two windings. One winding has terminals 621 and 622, and the other winding has terminals 631 and 632. Transformer 610 also is a two-layer transformer including metal layers 620 and 630. Each metal layer 620 and 630 is patterned to include multiple conductive segments as shown. The conductive segments of each winding of the transformer are labeled with the conductive segments of layer 620 labeled with the numeral “620” and an appended letter (e.g., 620a, 620b, 620c, etc.). The conductive segments of layer 630 are labeled with the numeral “630” and an appended letter (e.g., 630a, 460b, 460c, etc.). As for transformer 310, some conductive segments are predominantly linear (e.g., segment 620a) and some conductive segments have curved (or right-angle) corners (e.g., segment 620c). As described below, segments of layer 620 are coupled to segments of layer 630 through vias 615a, 615b, 616c, 616d, etc. (collectively, vias 615).

The conductive segments and associated vias 615 of one transformer winding (e.g., the primary winding) of the transformer 610 will now be identified starting at terminal 622 with conductive segment 620a and progressing toward the end of the winding at terminal 621. At the opposite end of conductive segment 620a from terminal 622, via 615a couples conductive segment 620a from layer 620 to conductive segment 630a in layer 630. Conductive segment 630a extends from via 610a around the transformer to via 610b. Via 610b couples conductive segment 630a from layer 630 to conductive segment 620b in layer 620. Conductive segment 620b extends around the transformer to via 610c. Via 610c couples conductive segment 620b from layer 620 to conductive segment 630b in layer 630. Conductive segment 630b in layer 630 extends back around the transformer to via 610d. Via 610d couples conductive segment 630b in layer 630 to conductive segment 620c in layer 620. Conductive segment 620c wraps around a portion of the transformer to via 615e. Via 615e couples conducive segment 620c in layer 620 to conductive segment 630c in layer 630. The opposite end of conductive segment 630c couples to via 615f, which couples conductive segment 630c to conductive segment 620d in layer 620. The end of conductive segment 620d is near (but does not touch) the initial conductive segment 620a. Terminal 621 is on the end of the conductive segment 620d near terminal 622.

The other winding (e.g., the secondary winding) of the transformer 610 is similarly constructed and is interleaved within the winding described above. The conductive segments and vias of this latter winding will now be identified starting at terminal 632 with conductive segment 620e and progressing towards terminal 631. At the opposite end of conductive segment 620e from terminal 632, via 615g couples conductive segment 620e from layer 620 to conductive segment 630d in layer 630. Conductive segment 630d extends from via 615g to via 615h. Via 615h couples conductive segment 630d from layer 630 to conductive segment 620f in layer 620. Conductive segment 620f extends around the transformer to via 615i. Via 615i couples conductive segment 620f from layer 620 to conductive segment 630e in layer 630. Conductive segment 630e in layer 630 extends back around the transformer to via 615j. Via 615j couples conductive segment 630e in layer 630 to conductive segment 620g. Segment 620g is coupled by a via (hidden from view) to conductive segment 630f. Conductive segment 630f extends around a portion of the transformer to a via (hidden from view) which couples conductive segment 630f to conductive segment 620h in layer 620, the opposite end of which includes terminal 631.

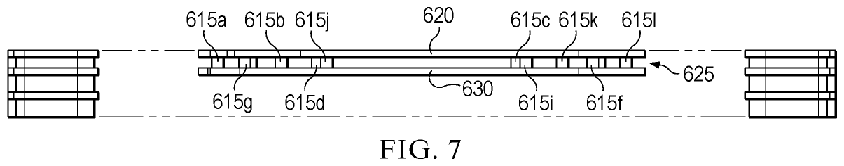

FIG. 7 shows a side view of transformer 610 illustrating the two layers 620 and 630. The two layers 620 and 630 are separated by dielectric material 625 (e.g., silicon dioxide). The vias 615 are shown including vias 615k and 615l. Via 615k is the via that was hidden in the view of FIG. 6 coupling together conductive segments 620g and 630f. Via 615l is the via that was hidden in the view of FIG. 6 coupling together conductive segments 630f and 620h.

The use of the two-layer transformer was described above as part of an isolation voltage converter. The two-layer transformer may be used as part of other applications as well.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal, “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead. For example, a p-channel field effect transistor (“PFET”) may be replaced by an NFET with little or no changes to the circuit. Furthermore, other types of transistors may be used (such as bipolar junction transistors (BJTs)). The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

Modifications are possible in the described embodiments, and other embodiments are possible, within the scope of the claims.

What is claimed is:

1. An apparatus, comprising:
a substrate;
a first conductive layer on the substrate, the first conductive layer comprising a first set of conductive segments and a second set of conductive segments;
a second conductive layer over the first conductive layer opposite the substrate, the second metal layer comprising a third set of conductive segments and a fourth set of conductive segments;
a first set of vias between the first set of conductive segments and the third set of conductive segments, wherein the first set of conductive segments, the third set of conductive segments, and the first set of vias form a first transformer winding; and
a second set of vias between the second set of conductive segments and the fourth set of conductive segments, wherein the second set of conductive segments, the fourth set of conductive segments, and the second set of vias form a second transformer winding.

2. The apparatus of claim 1, wherein the first transformer winding is interleaved with the second transformer winding.

3. The apparatus of claim 1, further including:
a first terminal on one of the conductive segments of the third set of conductive segments;
a second terminal on another conductive segment of the third set of conductive segments; and
a first die coupled to the first terminal and to the second terminal.

4. The apparatus of claim 3, wherein the first die is at least partially supported by the conductive segments of the third set of conductive segments that include the first terminal and the second terminal.

5. The apparatus of claim 3, further including:
a third terminal on one conductive segment of the fourth set of conductive segments;
a fourth terminal on another conductive segment of the fourth set of conductive segments;
a second die coupled to the third terminal and to the fourth terminal.

6. The apparatus of claim 5, wherein the second die is at least partially supported by the conductive segments of the fourth set of conductive segments that include the third terminal and the fourth terminal.

7. The apparatus of claim 5, wherein:
the first die includes transistors configured to provide a switching voltage waveform to be provided to the first transformer winding; and
the second die includes a rectifier configured to rectify the voltage from the second transformer winding.

8. The apparatus of claim 5, wherein the apparatus is an isolation voltage converter.

9. The apparatus of claim 1, wherein:
the first conductive layer is a metal; and
the second conductive layer is a metal.

10. A voltage converter, comprising:
a first semiconductor die including a power stage circuit;
a second semiconductor die including a rectifier; and
a transformer, comprising:
a substrate;
a first conductive layer on the substrate, the first conductive layer comprising a first set of conductive segments and a second set of conductive segments;
a second conductive layer over the first conductive layer opposite the substrate, the second conductive layer comprising a third set of conductive segments and a fourth set of conductive segments;
a first set of vias between the first set of conductive segments and the third set of conductive segments, wherein the first set of conductive segments, the third set of conductive segments, and the first set of vias form a first transformer winding, the first semiconductor die coupled to the first transformer winding; and
a second set of vias between the second set of conductive segments and the fourth set of conductive segments, wherein the second set of conductive segments, the fourth set of conductive segments, and the second set of vias form a second transformer winding, the second semiconductor die coupled to the second transformer winding.

11. The voltage converter of claim 10, wherein the first transformer winding is interleaved with the second transformer winding.

12. The voltage converter of claim 10, further including:
a first terminal on one of the conductive segments of the third set of conductive segments; and
a second terminal on another conductive segment of the third set of conductive segments;
wherein the first die coupled to the first terminal and to the second terminal.

13. The voltage converter of claim 12, wherein the first die is at least partially supported by the conductive segments of the third set of conductive segments that include the first terminal and the second terminal.

14. The voltage converter of claim 12, further including:
a third terminal on one conductive segment of the fourth set of conductive segments; and
a fourth terminal on another conductive segment of the fourth set of conductive segments;
wherein the second die is coupled to the third terminal and to the fourth terminal.

15. The voltage converter of claim 14, wherein the second die is at least partially supported by the conductive segments of the fourth set of conductive segments that include the third terminal and the fourth terminal.

16. The voltage converter of claim 10, wherein:
the first conductive layer is a metal; and
the second conductive layer is a metal.

17. A transformer, comprising:
a first transformer winding comprising:
a first set of metal segments in a first metal layer;
a second set of metal segments in a second metal layer; and
a first set of conductive vias coupling together the first set of metal segments to the second set of metal segments; and
a second transformer winding comprising:
a third set of metal segments in the first metal layer;
a fourth set of metal segments in the second metal layer; and
a second set of conductive vias coupling together the third set of metal segments to the fourth set of metal segments;
wherein the first transformer winding is interleaved with the second transformer winding.

18. The transformer of claim 17, wherein each of the first transforming winding and the second transformer winding has at least two turns.

19. The transformer of claim 17, further including a dielectric layer between the first metal layer and the second metal layer.

20. The transformer of claim 17, wherein at least one metal segment of the first set of metal segments is a different length than at least one metal segment of the second set of metal segments.
